(19) United States
(12) Patent Application Publication
(10) Pub. No.: US 2026/0370450 A1
(43) Pub. Date: Nov. 19, 2026

(54) ELECTRONIC APPARATUS AND CONTROLLING METHOD THEREOF

(71) Applicant: CRYPTO LAB INC., Seoul (KR)

(72) Inventor: Sunchul Jung, Seoul (KR)

(21) Appl. No.: 19/675,736

(22) Filed: May 13, 2026

(30) Foreign Application Priority Data
May 13, 2025 (KR) 10-2025-0062003
May 12, 2026 (KR) 10-2026-0085774

(51) Int. Cl. H04L 9/00; G06F 21/62

(52) U.S. Cl. CPC H04L 9/008; G06F 21/6209; G06F 21/6245

(57) ABSTRACT

An electronic apparatus and a controlling method thereof are disclosed. In particular, the electronic apparatus acquires a plurality of embeddings respectively corresponding to a plurality of data items stored in the memory; encrypts at least some embeddings among the plurality of embeddings by using a homomorphic encryption scheme and store the encrypted embeddings in the memory; when a search request including a query embedding generated based on a user query is received from an artificial intelligence agent, calculates an encrypted similarity score by performing a similarity operation between the query embedding and the at least some embeddings encrypted using the homomorphic encryption scheme without decryption; identifies at least one data item related to the search request among the plurality of data items based on a result of decrypting the encrypted similarity score; and when a user input for allowing access to the at least one data item is received, provides the at least one data item to be available for use by the artificial intelligence agent.

### CROSS-REFERENCE TO RELATED APPLICATION(S)

This application is based on and claims priority under 35 U.S.C. § 119(a) to Korean Patent Application No. 10-2025-0062003, filed on May 13, 2025, and Korean Patent Application No. 10-2026-0085774, filed on May 12, 2026, in the Korean Intellectual Property Office, the disclosures of which are incorporated by reference herein in their entireties.

### BACKGROUND

### 1. Field

The present disclosure relates to an electronic apparatus and a controlling method of an electronic apparatus, and relates to an electronic apparatus for controlling provision of user data to an artificial intelligence agent and a controlling method thereof.

### 2. Description of Related Art

Recently, an artificial intelligence agent is developing in a direction of providing a personalized response or service in consideration of a history, a preference, and a context of a user based on a natural language query of the user. For example, the artificial intelligence agent may perform a task such as travel planning, activity recommendation, or schedule suggestion by referring to a photo, a message, schedule information, location information, an activity history, or the like stored in an electronic apparatus.

The artificial intelligence agent may use an embedding indicating a semantic feature of a data item to process a user-related data item. However, the embedding may include sensitive information such as a location, a face, an object, an activity, or a preference of a user even when the embedding is not a data item itself. Accordingly, when the embedding is exposed to the artificial intelligence agent or an external agent without limitation, user-related information may be leaked even when the data item itself is not directly provided.

A conventional access authority control scheme mainly operates to allow or block access on an application basis or a file basis. However, when the artificial intelligence agent requires only a specific data item or only partial information of a specific data item based on a context of a user query, the conventional binary access authority control scheme may be excessively comprehensive or excessively restrictive.

In addition, a conventional security model is based on access control on a file basis, and it is thus difficult to appropriately protect semantic information included in an embedding in a vector-based artificial intelligence processing environment. In particular, in an environment in which a plurality of artificial intelligence agents cooperate with each other, sensitive information may be provided to a workflow between agents in a state in which the user does not recognize, thus requiring a trust framework for vector-based artificial intelligence processing.

Further, an on-device artificial intelligence agent has a potential to provide a personalized response by using user-related data in the electronic apparatus. However, when an infrastructure for safely retrieving and providing the user-related data or the embedding is not sufficient, it is difficult to sufficiently utilize the potential.

Accordingly, a demand has arisen for a technology capable of identifying a data item related to a user query and controlling whether to provide data and a data provision range based on a user input even in a state in which the artificial intelligence agent does not directly access an entire user-related data item.

### SUMMARY

The present disclosure provides an electronic apparatus capable of identifying at least one data item related to a user query and controlling whether to provide at least one data item or a provision range of at least one data item based on a user input even in a state in which an artificial intelligence agent does not directly access all of a plurality of data items stored in the electronic apparatus, and a controlling method of the electronic apparatus.

Additional aspects will be set forth in part in the following description, and in part will be apparent from the description, or may be learned by practice of the presented embodiments.

According to an aspect of the present disclosure, provided is an electronic apparatus including: at least one memory storing instructions; and at least one processor including processing circuitry, wherein the instructions, when executed individually or collectively by the at least one processor, cause the electronic apparatus to: acquire a plurality of embeddings respectively corresponding to a plurality of data items stored in the memory; encrypt at least some embeddings among the plurality of embeddings by using a homomorphic encryption scheme and store the encrypted embeddings in the memory; when a search request including a query embedding generated based on a user query is received from an artificial intelligence agent, calculate an encrypted similarity score by performing a similarity operation between the query embedding and the at least some embeddings encrypted using the homomorphic encryption scheme without decryption; identify at least one data item related to the search request among the plurality of data items based on a result of decrypting the encrypted similarity score; and when a user input for allowing access to the at least one data item is received, provide the at least one data item to be available for use by the artificial intelligence agent.

The instructions, when executed individually or collectively by the at least one processor, may cause the electronic apparatus to: when the at least one data item is identified, provide a user with access request information for inquiring whether to allow access to the at least one data item; and receive the user input as a response to the access request information.

The instructions, when executed individually or collectively by the at least one processor, may cause the electronic apparatus to: before the at least one data item is provided to the artificial intelligence agent, provide the user with the access request information including at least one of a type of the at least one data item, tag information corresponding to the at least one data item, or a target to which the at least one data item is to be provided.

The instructions, when executed individually or collectively by the at least one processor, may cause the electronic apparatus to: when a user input for not allowing access to the at least one data item is received, not provide the at least one data item to the artificial intelligence agent, and allow a response to the user query to be generated without using the at least one data item.

The artificial intelligence agent may be a first artificial intelligence agent, and the instructions, when executed individually or collectively by the at least one processor, may cause the electronic apparatus to: receive, from the first artificial intelligence agent, an external provision request for providing the at least one data item to a second artificial intelligence agent; and provide, based on user approval for the external provision request, the at least one data item to be available for use by the second artificial intelligence agent.

The external provision request may include at least one of identification information of the second artificial intelligence agent, information on a task to be performed by the second artificial intelligence agent, or a range of data to be provided to the second artificial intelligence agent.

The instructions, when executed individually or collectively by the at least one processor, may cause the electronic apparatus to: acquire privacy-related labels respectively corresponding to the plurality of data items; identify, based on the privacy-related labels and predefined policy information, an encryption target embedding to be encrypted and stored by using the homomorphic encryption scheme among the plurality of embeddings; and identify the at least some embeddings as the encryption target embeddings.

Decryption of the encrypted similarity score may be performed based on a decryption key managed in a trusted execution environment included in the electronic apparatus and inaccessible to the artificial intelligence agent, and the trusted execution environment may output information for identifying the at least one data item based on a result of decrypting the encrypted similarity score, and may not provide the decryption key to the artificial intelligence agent.

The instructions, when executed individually or collectively by the at least one processor, may cause the electronic apparatus to: identify the at least one data item based on the search request in a state in which the artificial intelligence agent does not have application-based access authority to the plurality of data items stored in the memory.

The instructions, when executed individually or collectively by the at least one processor, may cause the electronic apparatus to: provide access request information for the at least one data item through a conversational user interface corresponding to the user query; and determine whether to provide the at least one data item or a provision range of the at least one data item based on the user input received through the conversational user interface.

According to an aspect of the present disclosure, provided is a controlling method of an electronic apparatus, the method including: acquiring a plurality of embeddings respectively corresponding to a plurality of data items; encrypting at least some embeddings among the plurality of embeddings by using a homomorphic encryption scheme and storing the encrypted embeddings; when a search request including a query embedding generated based on a user query is received from an artificial intelligence agent, calculating an encrypted similarity score by performing a similarity operation between the query embedding and the at least some embeddings encrypted using the homomorphic encryption scheme without decryption; identifying at least one data item related to the search request among the plurality of data items based on a result of decrypting the encrypted similarity score; and when a user input for allowing access to the at least one data item is received, providing the at least one data item to be available for use by the artificial intelligence agent.

According to an aspect of the present disclosure, provided is a non-transitory computer-readable recording medium including a program for executing a controlling method of an electronic apparatus, wherein the method includes: acquiring a plurality of embeddings respectively corresponding to a plurality of data items; encrypting at least some embeddings among the plurality of embeddings by using a homomorphic encryption scheme and storing the encrypted embeddings; when a search request including a query embedding generated based on a user query is received from an artificial intelligence agent, calculating an encrypted similarity score by performing a similarity operation between the query embedding and the at least some embeddings encrypted using the homomorphic encryption scheme without decryption; identifying at least one data item related to the search request among the plurality of data items based on a result of decrypting the encrypted similarity score; and when a user input for allowing access to the at least one data item is received, providing the at least one data item to be available for use by the artificial intelligence agent.

According to an aspect of the present disclosure, an electronic apparatus or a computing platform may provide a privacy mediation layer implemented as a system service, a platform service, a local agent proxy, or a data access mediation layer operating at an operating system or platform service level. The privacy mediation layer may identify a data item or a derived context corresponding to a purpose of a user query even in a state in which an artificial intelligence agent does not have comprehensive application-based or file-based access authority to user data items, and may determine a range of information that is providable to the artificial intelligence agent based on a privacy-related label and policy information. Accordingly, the electronic apparatus or the computing platform may support a personalized artificial intelligence service by providing an activity tag, summary information, metadata, a partial field, or a redacted derived context without directly providing an original data item or a sensitive embedding.

### BRIEF DESCRIPTION OF THE DRAWINGS

FIG. 1 is a block diagram briefly illustrating a configuration of an electronic apparatus according to an embodiment of the present disclosure;

FIG. 2 is a block diagram illustrating a plurality of modules and input/output of each of the modules according to an embodiment of the present disclosure;

FIG. 3 is a block diagram illustrating a detailed configuration of the electronic apparatus according to an embodiment of the present disclosure;

FIG. 4 is a block diagram illustrating additional modules and input/output of each of the modules according to an embodiment of the present disclosure;

FIG. 5 is a diagram illustrating examples of user interfaces according to an embodiment of the present disclosure; and

FIG. 6 is a flowchart illustrating a controlling method of an electronic apparatus according to an embodiment of the present disclosure.

### DETAILED DESCRIPTION

The present disclosure may be variously modified and may have various embodiments, and specific embodiments of the present disclosure are thus illustrated in the accompanying drawings and described in detail in the detailed description. However, it should be understood that the scope of the present disclosure is not limited to specific embodiments, and include various modifications, equivalents, and/or alternatives according to embodiments of the present disclosure. Throughout the drawings, similar components are denoted by similar reference numerals.

In describing the present disclosure, omitted is a detailed description of a case where it is decided that a detailed description of the known functions or configurations related to the present disclosure may unnecessarily obscure the gist of the present disclosure.

In addition, the following embodiment may be modified in several different forms, and the scope and spirit of the present disclosure are not limited to the following embodiments. Rather, these embodiments make the present disclosure thorough and complete, and are provided to completely convey the spirit of the present disclosure to those skilled in the art.

Terms used in the present disclosure are used only to describe specific embodiments and are not intended to limit the scope of the present disclosure. Singular expressions may include plural expressions unless the context clearly indicates otherwise.

In the present disclosure, the expression such as “have,” “may have,” “include,” or “may include,” indicates the presence of a corresponding feature (e.g., a numerical value, a function, an operation, or a component such as a part), and does not exclude the presence of an additional feature.

In the present disclosure, expressions such as “A or B,” “at least one of A or/and B,” or “one or more of A or/and B” may include all possible combinations of items enumerated together. For example, “A or B,” “at least one of A and B,” or “at least one of A or B” may indicate all of (1) including at least one A, (2) including at least one B, or (3) including both at least one A and at least one B.

In the present disclosure, expressions such as “first,” “second,” “firstly,” or “secondly” may modify various components regardless of order and/or importance, and are used only to distinguish one component from another component, and do not limit the corresponding components.

When it is described that a component (e.g., a first component) is “(operatively or communicatively) coupled with/to” or “connected to” another component (e.g., a second component), it should be understood that the component may be directly connected to the other component or may be connected through another component (e.g., a third component).

On the other hand, when it is described that a component (e.g., a first component) is “directly connected to” or “directly coupled to” another component (e.g., a second component), it may be understood that no other component (e.g., a third component) is present between the component and the other component.

In the present disclosure, an expression “configured to (or set to)” may be replaced with, for example, “suitable for,” “having the capacity to,” “designed to,” “adapted to,” “made to,” or “capable of,” depending on a context. The term “configured to (or set to)” may not necessarily refer to only “specifically designed to” in terms of hardware.

Instead, in some contexts, an expression “a device configured to” may refer to a device capable of “performing” a corresponding function in combination with another device or component. For example, a phrase “a processor configured to (or set to) perform A, B, and C” may refer to a dedicated processor (e.g., an embedded processor) capable of performing the corresponding operation, or a generic-purpose processor (e.g., a central processing unit (CPU) or an application processor) capable of performing the operation by executing one or more software programs stored in a memory device.

In an embodiment, a “module” or a “unit” may perform at least one function or operation, and may be implemented as hardware, software, or a combination of hardware and software. In addition, a plurality of “modules” or a plurality of “units” may be integrated into at least one module and implemented by at least one processor, except for a “module” or a “unit” that needs to be implemented in specific hardware.

Meanwhile, various elements and regions in the drawings are schematically illustrated. Accordingly, the spirit of the present disclosure is not limited by relative sizes or intervals illustrated in the accompanying drawings.

Hereinafter, embodiments of the present disclosure will be described in detail with reference to the accompanying drawings to allow those skilled in the art to which the present disclosure pertains to easily implement the present disclosure.

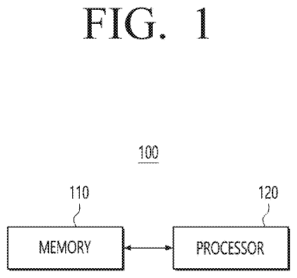

FIG. 1 is a block diagram briefly illustrating a configuration of an electronic apparatus 100 according to an embodiment of the present disclosure.

The electronic apparatus 100 according to the present disclosure may refer to a device for controlling provision of a data item available for use by an artificial intelligence agent based on a user query. For example, the electronic apparatus 100 may be implemented as at least one of a smartphone, a tablet personal computer (PC), a wearable device, a laptop computer, a desktop computer, a television, a home appliance, a vehicle electronic apparatus, a server, or a cloud system. However, the electronic apparatus 100 is not limited thereto, and may be implemented as various devices or systems capable of storing a user-related data item or controlling access to a user-related data item. In addition, the electronic apparatus 100 may be implemented as a plurality of devices rather than one device.

As illustrated in FIG. 1, the electronic apparatus 100 may include a memory 110 and a processor 120.

At least one instruction related to the electronic apparatus 100 may be stored in the memory 110. In addition, an operating system (O/S) for driving the electronic apparatus 100 may be stored in the memory 110. In addition, various software programs or applications for operating the electronic apparatus 100 according to various embodiments of the present disclosure may be stored in the memory 110. In addition, the memory 110 may include a semiconductor memory such as a flash memory, a magnetic storage medium such as a hard disk, or the like.

Specifically, various software modules for operating the electronic apparatus 100 according to various embodiments of the present disclosure may be stored in the memory 110, and the processor 120 may control an operation of the electronic apparatus 100 by executing the various software modules stored in the memory 110. That is, the memory 110 may be accessed by the processor 120, and the processor 120 may perform reading, writing, modifying, deleting, updating, or the like of data.

Meanwhile, in the present disclosure, the term “memory 110” may be used to include the memory 110, a read-only memory (ROM) or a random access memory (RAM) included in the processor 120, or a memory card (for example, a micro secure digital card (micro SD card), a memory stick) mounted in the electronic apparatus 100.

In an embodiment, the memory 110 may store at least one of a plurality of data items, a plurality of embeddings respectively corresponding to the plurality of data items, at least some embeddings encrypted using a homomorphic encryption scheme, information for identifying at least one data item related to a user query, or information for determining whether to provide at least one data item or a provision range of at least one data item. In addition, various information required within a scope for achieving an object of the present disclosure may be stored in the memory 110, and the information stored in the memory 110 may be updated as being received from an external device or input by a user.

The processor 120 may control overall operations of the electronic apparatus 100. Specifically, the processor 120 may be connected to a configuration of the electronic apparatus 100 including a communication interface 130 and the memory 110. The processor 120 may include processing circuitry, and may be implemented as at least one processor 120. That is, the processor 120 may be implemented as one or more processors 120. The processor 120 may control an operation of the electronic apparatus 100 by executing instructions stored in the memory 110 individually or collectively.

The processor 120 may be implemented in various ways. For example, the processor 120 may be implemented as at least one of an application specific integrated circuit (ASIC), an embedded processor, a microprocessor, a hardware control logic, a hardware finite state machine (FSM), or a digital signal processor (DSP). Meanwhile, in the present disclosure, the term “processor 120” may be used to include a central processing unit (CPU), a graphic processing unit (GPU), a microprocessor unit (MPU), or the like.

In an embodiment, by executing instructions stored in the memory 110, the processor 120 may acquire a plurality of embeddings respectively corresponding to a plurality of data items, encrypt at least some embeddings among the plurality of embeddings by using a homomorphic encryption scheme and store the encrypted embeddings, may identify at least one data item related to a search request when the search request based on a user query is received from an artificial intelligence agent, and may provide at least one data item to the artificial intelligence agent to be available for use based on a user input.

Hereinafter, various embodiments implemented by the processor 120 will be described in more detail with reference to the drawings.

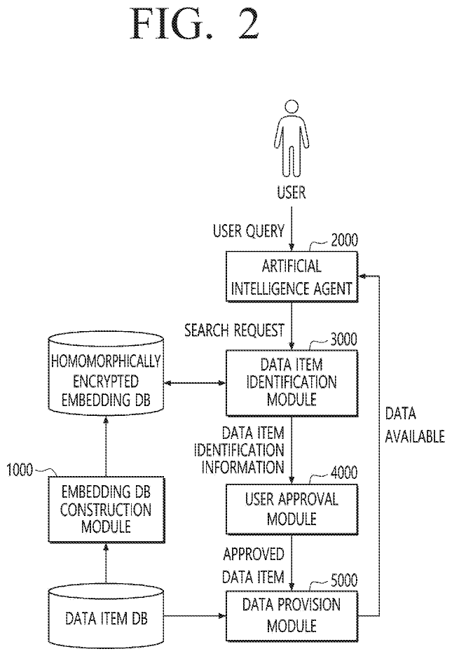

FIG. 2 is a block diagram illustrating a plurality of modules and input/output of each of the modules according to an embodiment of the present disclosure.

Referring to FIG. 2, the electronic apparatus 100 may include an embedding database (DB) construction module 1000, an artificial intelligence agent 2000, a data item identification module 3000, a user approval module 4000, and a data provision module 5000. The plurality of modules may be implemented as software modules or hardware modules. At least one of the plurality of modules may include a trained neural network, and two or more of the plurality of modules may be implemented as one integrated module. At least one module among the plurality of modules may be implemented by an external device.

In an embodiment, at least one of the embedding DB construction module 1000, the data item identification module 3000, the user approval module 4000, or the data provision module 5000 may be implemented as a system service included in an operating system of the electronic apparatus 100. For example, the system service may control retrieval and provision of a data item related to a user query based on a user input even in a state in which the artificial intelligence agent 2000 does not have application-based access authority to a plurality of data items.

In an embodiment, by executing instructions stored in the memory 110, the processor 120 may use at least one of the embedding DB construction module 1000, the artificial intelligence agent 2000, the data item identification module 3000, the user approval module 4000, or the data provision module 5000.

The processor 120 may acquire a plurality of embeddings respectively corresponding to a plurality of data items stored in the memory 110. Specifically, the processor 120 may acquire the plurality of embeddings respectively corresponding to the plurality of data items stored in the memory 110 by using the embedding DB construction module 1000.

A data item may refer to data stored in the memory 110 of the electronic apparatus 100. For example, the data item may include at least one of text, a photo, or audio. As another example, the data item may include at least one of a video, a message, a document, schedule information, location information, an application usage history, user setting information, or a user activity history. The term “data item” may refer to each item of various data stored in the electronic apparatus.

An embedding may refer to data representing a semantic feature of a data item in a vector form. For example, an embedding corresponding to a photo may represent features of a place, an object, a person, an activity, or a scene included in the photo in a vector form. An embedding corresponding to text may represent features of a word, a sentence, a topic, an intention, or a context included in the text in a vector form. An embedding corresponding to audio may represent features of speech content, voice characteristics, or sound characteristics included in the audio in a vector form.

In an embodiment, the processor 120 may acquire the plurality of data items stored in the memory 110 by using the embedding DB construction module 1000. The processor 120 may acquire the plurality of embeddings respectively corresponding to the plurality of data items by inputting each of the plurality of data items into a vector embedding pipeline. For example, the vector embedding pipeline may be implemented based on at least one of contrastive language-image pre-training (CLIP), Whisper, vision transformer (ViT), or Transformer.

In an embodiment, the processor 120 may select one of a plurality of embedding models based on a type of a data item, and acquire an embedding corresponding to the data item by using the selected embedding model. For example, the processor 120 may acquire a photo embedding by inputting a photo data item into an image embedding model, acquire a text embedding by inputting a text data item into a text embedding model, and acquire an audio embedding by inputting an audio data item into an audio embedding model.

In an embodiment, the processor 120 may acquire the plurality of embeddings by inputting at least one of a photo, text, or audio into a multimodal embedding model. Accordingly, embeddings corresponding to different types of data items may be compared in a common embedding space. For example, the processor 120 may acquire the plurality of embeddings respectively corresponding to the plurality of data items to enable a similarity operation between a query embedding corresponding to a user query in a text form and a photo embedding corresponding to a photo data item.

In an embodiment, the processor 120 may map each of the plurality of data items and each of the plurality of embeddings to each other. In an embodiment, the processor 120 may store identification information of a data item stored in a data item DB and identification information of an encrypted embedding stored in a homomorphically encrypted embedding DB in a mapped manner. Accordingly, the processor 120 may refer to a data item related to a search request by using an embedding identified based on an encrypted similarity score. In addition, the processor 120 may store at least one of tag information corresponding to a data item, a privacy-related label, or metadata together with an embedding.

The processor 120 may encrypt at least some embeddings among the plurality of embeddings by using a homomorphic encryption scheme and store the encrypted embeddings in the memory 110. Specifically, the processor 120 may encrypt at least some embeddings among the plurality of embeddings by using a homomorphic encryption scheme by using the embedding DB construction module 1000, and may store at least some embeddings encrypted using the homomorphic encryption scheme in the encrypted embedding DB.

A homomorphic encryption scheme may refer to an encryption scheme that enables an operation on a ciphertext without decrypting the ciphertext. In an embodiment, the homomorphic encryption scheme may be implemented based on an approximate homomorphic encryption scheme such as Cheon-Kim-Kim-Song (CKKS), and is not limited thereto. Accordingly, the processor 120 may store at least some embeddings in an encrypted state, and may enable a similarity operation between a query embedding and an encrypted embedding to be performed without decryption.

In an embodiment, the processor 120 may encrypt and store all of the plurality of embeddings by using a homomorphic encryption scheme. In another embodiment, the processor 120 may identify some embeddings requiring privacy protection among the plurality of embeddings, and may encrypt and store the identified some embeddings by using a homomorphic encryption scheme.

The processor 120 may identify at least some embeddings to be encrypted and stored by using a homomorphic encryption scheme based on at least one of a privacy-related label corresponding to each of the plurality of data items, predefined policy information, or a type of a data item. For example, when a privacy-related label corresponding to a data item includes a label related to location information, personal identification information, or health information, the processor 120 may identify an embedding corresponding to the data item as the encryption target embedding.

The processor 120 may encrypt an encryption target embedding by using a homomorphic encryption scheme and may store the encrypted embedding in the encrypted embedding DB. The encrypted embedding DB may refer to a storage region for storing a plurality of encrypted embeddings. In an embodiment, the encrypted embedding DB may be included in a secure storage region in the memory 110. In another embodiment, the encrypted embedding DB may be included in a storage region of a system service managed by an operating system of the electronic apparatus 100.

In an embodiment, the processor 120 may store an encrypted embedding and identification information of a data item in a mapped manner. For example, the processor 120 may map identification information of an encrypted embedding and identification information of a data item corresponding to the encrypted embedding to each other. In addition, the processor 120 may store at least one of a type of a data item, tag information, a privacy-related label, or metadata together with the encrypted embedding.

When a search request including a query embedding generated based on a user query is received from an artificial intelligence agent (AI Agent) 2000, the processor 120 may calculate an encrypted similarity score by performing a similarity operation between the query embedding and at least some embeddings encrypted using a homomorphic encryption scheme without decryption.

The artificial intelligence agent 2000 may refer to software, a model, an application, a service, or a combination thereof that performs a task corresponding to a user query or generates a response to a user query based on the user query. In an embodiment, the artificial intelligence agent 2000 may be an on-device artificial intelligence agent executed in the electronic apparatus 100. In another embodiment, the artificial intelligence agent 2000 may be an artificial intelligence agent that operates in conjunction with a server or a cloud system outside the electronic apparatus 100. The artificial intelligence agent may be implemented as a set of a plurality of neural network models.

In an embodiment, the processor 120 may receive a search request from the artificial intelligence agent 2000 by using the data item identification module 3000. The search request may include a query embedding generated based on a user query.

In an embodiment, the search request may be received through an agent interface called by the artificial intelligence agent 2000 to use data, tools, or context of the electronic apparatus 100. For example, the agent interface may be implemented based on Model Context Protocol (MCP). However, the agent interface is not limited thereto and may be implemented as various interfaces through which the artificial intelligence agent may call a system service or the data item identification module 3000.

A user query may refer to a request in a natural language form input by a user to the artificial intelligence agent 2000. For example, the user query may include a sentence requesting retrieval, recommendation, recollection, or task execution based on past activities, a photo, text, audio, or another user-related data item of the user.

A query embedding may refer to data representing a semantic feature of a user query in a vector form. In an embodiment, the artificial intelligence agent 2000 may generate the query embedding by inputting the user query into an embedding model. In another embodiment, the processor 120 may receive the user query from the artificial intelligence agent 2000 and may generate the query embedding based on the user query.

A search request may include at least one of a range of a search target, a purpose of a query, identification information of the artificial intelligence agent 2000, or information on a requested task together with the query embedding. For example, the search request may further include information specifying a data item corresponding to a specific period, a specific location, a specific data type, or a specific application as a search target.

In an embodiment, when the search request is received, the processor 120 may identify at least some embeddings stored in the encrypted embedding DB. At least some embeddings may be embeddings encrypted using a homomorphic encryption scheme and stored. Accordingly, the processor 120 may perform a similarity operation between the query embedding and at least some embeddings without decrypting at least some embeddings.

A similarity operation may refer to an operation for calculating a semantic relation between a query embedding and an embedding corresponding to a data item. For example, the similarity operation may include at least one of an inner product operation, a cosine similarity operation, or a distance-based operation. In this case, the processor 120 may perform a ciphertext operation corresponding to the similarity operation by using an operation characteristic of the homomorphic encryption scheme in a state in which an encrypted embedding is not decrypted.

In an embodiment, a query embedding may be an embedding in a plaintext state, and at least some embeddings may be embeddings encrypted using a homomorphic encryption scheme. In this case, the processor 120 may calculate an encrypted similarity score by performing a similarity operation between the query embedding in a plaintext state and the encrypted embedding. In another embodiment, a query embedding may also be encrypted using a homomorphic encryption scheme and included in a search request, and the processor 120 may perform a similarity operation between the encrypted query embedding and the encrypted embedding.

An encrypted similarity score may refer to data representing a similarity between a query embedding and an embedding corresponding to a data item, and a similarity value itself may be represented in a ciphertext state. That is, the artificial intelligence agent 2000 is unable to directly check content of a data item or a specific magnitude of a similarity value based only on the encrypted similarity score.

For example, when a user requests a recommendation related to a past trip from the artificial intelligence agent 2000, the artificial intelligence agent 2000 may generate a query embedding based on the user query, and may provide a search request including the query embedding to the data item identification module 3000. The processor 120 may perform a similarity operation between the query embedding and encrypted embeddings stored in the encrypted embedding DB without decryption, by using the data item identification module 3000. Accordingly, the processor 120 may calculate encrypted similarity scores corresponding to data items likely to be related to the user query.

As described above, the processor 120 may perform a similarity operation between the query embedding and the encrypted embedding even in a state in which the artificial intelligence agent 2000 does not directly access a plurality of data items stored in the memory 110. In addition, the processor 120 may reduce exposure of semantic features of data items to the artificial intelligence agent 2000 by performing the similarity operation without decrypting embeddings corresponding to the plurality of data items.

The processor 120 may identify at least one data item related to a search request among a plurality of data items based on a result of decrypting an encrypted similarity score. Specifically, the processor 120 may acquire the result of decrypting the encrypted similarity score by using the data item identification module 3000. The result of decrypting the encrypted similarity score may include a similarity score indicating a semantic relation between the query embedding and an embedding corresponding to each of the plurality of data items.

In an embodiment, decryption of the encrypted similarity score may be performed based on a trusted execution environment (TEE) included in the electronic apparatus 100. The trusted execution environment may refer to a region for managing a decryption key for decrypting the encrypted similarity score. For example, the trusted execution environment may be implemented as a region inaccessible to the artificial intelligence agent 2000.

The processor 120 may decrypt the encrypted similarity score by using the trusted execution environment. In this case, the trusted execution environment may provide a result of decrypting the encrypted similarity score or information on a data item identified based on the result of decrypting the encrypted similarity score to the data item identification module 3000. The trusted execution environment may not provide the decryption key to the artificial intelligence agent 2000.

In an embodiment, the processor 120 may identify at least one data item related to the search request among the plurality of data items based on a decrypted similarity score. For example, the processor 120 may identify a data item having the highest similarity score among the plurality of data items as a data item related to the search request.

As another example, the processor 120 may identify at least one data item having a similarity score equal to or greater than a predetermined threshold value as at least one data item related to the search request. As still another example, the processor 120 may identify, as at least one data item related to the search request, an upper predetermined number of data items based on a ranking of similarity scores.

In an embodiment, the processor 120 may first acquire information for identifying at least one data item without immediately providing at least one data item itself to the artificial intelligence agent 2000. The processor 120 may identify at least one data item related to the user query based on a homomorphically encrypted embedding without first decrypting the data item itself. The information for identifying at least one data item may include at least one of identification information of a data item, a type of the data item, tag information corresponding to the data item, a storage location of the data item, or metadata corresponding to the data item.

For example, when a user inputs a user query related to a past trip, the processor 120 may identify, as a data item related to the search request, at least one of a photo, a message, or schedule information related to the past trip based on a result of decrypting similarity scores between the query embedding and encrypted embeddings. In this case, the processor 120 may perform a subsequent operation for inquiring of the user whether to allow access to the identified data item without immediately providing original content of the identified data item to the artificial intelligence agent 2000.

Accordingly, the processor 120 may identify at least one data item semantically related to the user query even in a state in which the artificial intelligence agent 2000 does not directly access all of the plurality of data items. In addition, the processor 120 may reduce direct exposure of a decryption key or a semantic feature of a data item to the artificial intelligence agent 2000 by performing decryption of a similarity score in the trusted execution environment.

When a user input for allowing access to at least one data item is received, the processor 120 may provide at least one data item to be available for use by the artificial intelligence agent. Specifically, the processor 120 may provide a user with access request information for inquiring whether to allow access to at least one data item related to the search request by using the user approval module 4000. The access request information may be information provided to the user before the artificial intelligence agent 2000 uses at least one data item.

In an embodiment, the access request information may include at least one of a type of at least one data item, tag information corresponding to at least one data item, or a target to which at least one data item is to be provided. For example, the access request information may include a conversational message indicating that a photo related to the search request is identified and inquiring whether to allow access to the identified photo. As another example, the access request information may include information indicating which type of data item among a photo, a message, or schedule information the identified data item is.

In an embodiment, the processor 120 may provide the access request information through a conversational user interface. For example, the processor 120 may provide the access request information for at least one data item through a conversation screen between the artificial intelligence agent 2000 and the user. Accordingly, the user may determine whether to allow access to at least one data item in a state in which the user recognizes that a data item related to the search request exists.

In an embodiment, the processor 120 may dynamically generate the access request information based on at least one of content of a user query, a purpose of a search request, a type of an identified data item, a target to which the identified data item is to be provided, or a usage purpose of the identified data item. Accordingly, before the data item is provided to the artificial intelligence agent 2000, the user may determine whether to allow access in a state in which the user recognizes a provision target, a provision range, or a usage purpose. The processor 120 may receive a user input as a response to the access request information. The user input may be an input for allowing access to at least one data item. For example, the user input may include at least one of an approval command, a selection input, a voice input, or a touch input that is input through the conversational user interface.

When a user input for allowing access to at least one data item is received, the processor 120 may provide at least one data item to be available for use by the artificial intelligence agent 2000 by using the data provision module 5000. “Providing to be available for use” may refer to allowing the artificial intelligence agent 2000 to refer to at least one data item to generate a response to a user query or perform a task corresponding to the user query.

In an embodiment, the processor 120 may provide at least one data item itself to the artificial intelligence agent 2000. In another embodiment, the processor 120 may provide at least one of metadata, summary information, tag information, or a part of a data item corresponding to at least one data item to the artificial intelligence agent 2000. In still another embodiment, the processor 120 may provide only a partial region, a partial field, or a partial attribute of at least one data item to the artificial intelligence agent 2000 within a range allowed by a user input.

In an embodiment, after providing at least one data item to be available for use by the artificial intelligence agent 2000, the processor 120 may allow the artificial intelligence agent 2000 to generate a response to a user query based on at least one data item. For example, when a user requests a recommendation related to a past trip, the processor 120 may provide at least one of a past trip photo, a message, or schedule information for which access is allowed by the user to be available for use by the artificial intelligence agent 2000. The artificial intelligence agent 2000 may generate recommendation information corresponding to the user query based on the provided data item.

In an embodiment, when a user input for not allowing access to at least one data item is received, the processor 120 may not provide at least one data item to the artificial intelligence agent 2000. In this case, the processor 120 may allow a response to the user query to be generated without using at least one data item. For example, the processor 120 may allow the artificial intelligence agent 2000 to generate a response to the user query based on existing knowledge of the artificial intelligence agent 2000 or information separately provided by the user without using a data item related to the search request.

According to the embodiments described above, the electronic apparatus 100 may restrict automatic access of the artificial intelligence agent 2000 to a data item of a user, and may provide a data item related to a query (request) of the user to be available for use by the artificial intelligence agent 2000 when user approval is acquired. In addition, the electronic apparatus 100 may control only a data item related to the user query to be used in a restricted manner by combining an encrypted embedding-based search result with a user input.

In addition, the electronic apparatus 100 may prevent original content of a data item or a semantic feature of an embedding from being directly exposed to the artificial intelligence agent 2000 by encrypting at least some embeddings among embeddings respectively corresponding to a plurality of data items by using a homomorphic encryption scheme, storing the encrypted embeddings, and performing a similarity operation between a query embedding and an encrypted embedding without decryption.

In addition, after identifying a data item related to the user query based on an encrypted similarity score, the electronic apparatus 100 may provide the user with the access request information including at least one of a type of the data item, tag information corresponding to the data item, or a target to which the data item is to be provided. Accordingly, before an actual data item is provided, the user may determine whether to allow access in a state in which the user recognizes at least one of existence of a data item related to the user query, necessity of access, or a provision target.

In addition, the electronic apparatus 100 may identify a data item related to the user query through an encrypted embedding-based similarity operation even in a state in which the artificial intelligence agent 2000 does not have application-based access authority to the plurality of data items. Accordingly, data utilization according to a context of the user query may be possible without granting comprehensive application-based access authority to the artificial intelligence agent 2000.

In addition, the electronic apparatus 100 may provide more granular authority control than a batch allowance scheme or batch blocking scheme by determining whether to provide at least one data item or a provision range of at least one data item based on a user input. Accordingly, utilization of user data and privacy protection may be improved together in an artificial intelligence agent-based service.

In addition, the electronic apparatus 100 may mediate data access of the artificial intelligence agent 2000 through an operating system-level system service or agent interface. Accordingly, the electronic apparatus 100 may provide only a data item related to a user query within a range allowed by a user input without granting, to the artificial intelligence agent 2000, comprehensive access authority to all of a plurality of data items.

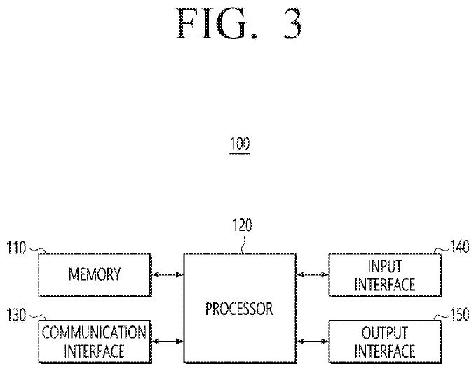

FIG. 3 is a block diagram illustrating a detailed configuration of the electronic apparatus 100 according to an embodiment of the present disclosure.

As illustrated in FIG. 3, the electronic apparatus 100 may further include the communication interface 130, an input interface 140, and an output interface 150, in addition to the memory 110 and the processor 120. However, components illustrated in FIGS. 1 and 3 are merely exemplary, and a new component may be added or some components may be omitted in addition to the components illustrated in FIGS. 1 and 3 in implementing the present disclosure.

The communication interface 130 may include circuitry and perform communication with an external device. Specifically, the processor 120 may receive various data or information from an external device connected through the communication interface 130, and may also transmit various data or information to the external device.

The communication interface 130 may include at least one of a wireless fidelity (Wi-Fi) module, a Bluetooth module, a wireless communication module, a near field communication (NFC) module, or an ultra-wide band (UWB) module. Specifically, each of the Wi-Fi module and the Bluetooth module may perform communication in a Wi-Fi scheme or a Bluetooth scheme. When using the Wi-Fi module or the Bluetooth module, the communication interface 130 may first transmit and receive various connection information such as a service set identifier (SSID), and may transmit and receive various information after communication connection by using the various connection information.

In addition, the wireless communication module may perform communication according to various communication standards such as Institute of Electrical and Electronics Engineers (IEEE), Zigbee, third generation (3G), third generation partnership project (3GPP), long term evolution (LTE), and fifth generation (5G). The NFC module may perform communication by using a near-field communication (NFC) method using a frequency band of 13.56 MHz among various radio frequency identification (RF-ID) frequency bands (e.g., 135 kHz, 13.56 MHz, 433 MHz, 860-960 MHz, and 2.45 GHz). The UWB module may perform precise distance and position recognition within an error range of several centimeters indoors by accurately measuring a time of arrival (ToA) and an angle of arrival (AoA) through communication between UWB antennas.

In an embodiment, the communication interface 130 may perform communication with at least one of an artificial intelligence agent, an external artificial intelligence agent, or an external server. For example, the communication interface 130 may transmit and receive at least one of a search request based on a user query, an external provision request, at least one data item, or metadata corresponding to at least one data item.

The input interface 140 may include circuitry, and the processor 120 may receive a user command for controlling an operation of the electronic apparatus 100 through the input interface 140. Specifically, the input interface 140 may include components such as a microphone, a camera, and a remote control signal receiver. In addition, the input interface 140 may be implemented as a touch screen included in a display. In particular, the microphone may receive a voice signal and convert the received voice signal into an electrical signal.

In an embodiment, the input interface 140 may receive at least one of a user query, a user input for allowing access to at least one data item, a user input for not allowing access to at least one data item, or a user input for specifying a provision range of at least one data item.

The output interface 150 includes circuitry, and the processor 120 may output various functions executable by the electronic apparatus 100 through the output interface 150. In addition, the output interface 150 may include at least one of a display, a speaker, or an indicator.

The display may output image data under control of the processor 120. Specifically, the display may output an image prestored in the memory 110 under control of the processor 120. In particular, the display according to an embodiment of the present disclosure may also display a user interface (UI) stored in the memory 110. The display may be implemented as a liquid crystal display panel (LCD), organic light emitting diodes (OLED), or the like, and the display may also be implemented as a flexible display, a transparent display, or the like in some cases. However, the display according to the present disclosure is not limited to a specific type.

The speaker may output audio data under control of the processor 120. The indicator may be turned on under control of the processor 120. Specifically, the indicator may be turned on in various colors according to control of the processor 120. For example, the indicator may be implemented as light emitting diodes (LED), a liquid crystal display panel (LCD), a vacuum fluorescent display (VFD), or the like, and is not limited thereto.

In an embodiment, the output interface 150 may output at least one of a conversational user interface corresponding to a user query, access request information for at least one data item, a response to the user query, information on an agent contributing to generating the response, or a reason why the agent is included in generating the response.

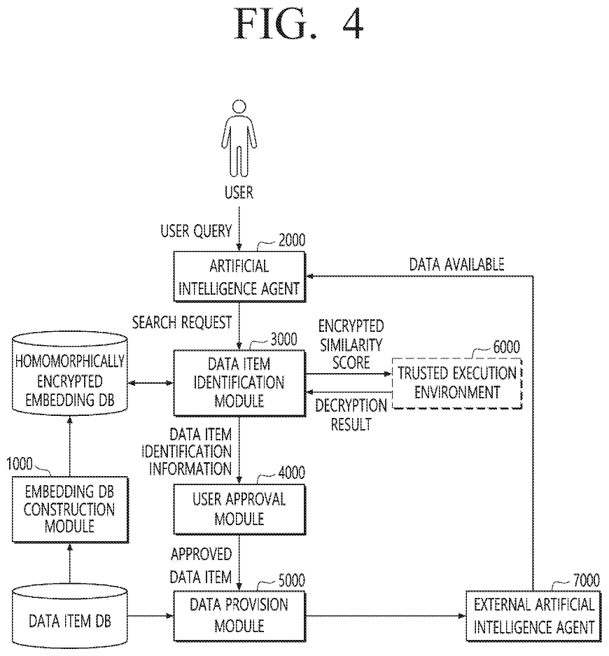

FIG. 4 is a block diagram illustrating additional modules and input/output of each of the modules according to an embodiment of the present disclosure.

Referring to FIG. 4, the electronic apparatus 100 may include the embedding DB construction module 1000, the artificial intelligence agent 2000, the data item identification module 3000, the user approval module 4000, the data provision module 5000, a trusted execution environment 6000, and an external artificial intelligence agent 7000.

In an embodiment, by executing instructions stored in the memory 110, the processor 120 may use at least one of the embedding DB construction module 1000, the artificial intelligence agent 2000, the data item identification module 3000, the user approval module 4000, the data provision module 5000, the trusted execution environment 6000, or the external artificial intelligence agent 7000.

Hereinafter, additional embodiments implemented through the modules illustrated in FIG. 2 will be described, and embodiments implemented through the additional modules illustrated in FIG. 4 will be described.

As described above in the description provided with reference to FIG. 2, the processor 120 may acquire the plurality of embeddings respectively corresponding to the plurality of data items by using the embedding DB construction module 1000, encrypt at least some embeddings among the plurality of embeddings by using the homomorphic encryption scheme, and store the encrypted embeddings. In addition, the processor 120 may store identification information of a data item stored in the data item DB and identification information of an encrypted embedding stored in the homomorphically encrypted embedding DB in a mapped manner.

In an embodiment, the processor 120 may identify an encryption target embedding among a plurality of embeddings based on privacy-related labels respectively corresponding to the plurality of data items and predefined policy information. For example, the processor 120 may identify, as the encryption target embedding, an embedding corresponding to a data item to which a privacy-related label related to location information, personal identification information, or health information is assigned.

When a search request including a query embedding generated based on a user query is received from the artificial intelligence agent 2000, the processor 120 may calculate an encrypted similarity score by performing a similarity operation between the query embedding and at least some embeddings encrypted using a homomorphic encryption scheme without decryption, by using the data item identification module 3000. In an embodiment, the query embedding may be an embedding in a plaintext state, and in another embodiment, the query embedding may also be encrypted using a homomorphic encryption scheme and included in the search request.

The processor 120 may provide an encrypted similarity score to the trusted execution environment 6000 by using the data item identification module 3000. The trusted execution environment 6000 may manage a decryption key for decrypting the encrypted similarity score. In an embodiment, the trusted execution environment 6000 may be implemented as a region inaccessible to the artificial intelligence agent 2000.

In an embodiment, the trusted execution environment 6000 may be implemented as a trusted execution region isolated from an operating system region, a general application region, or an execution region of the artificial intelligence agent 2000 of the electronic apparatus 100. The trusted execution environment 6000 may manage the decryption key for decrypting the encrypted similarity score, and may not provide the decryption key to the artificial intelligence agent 2000.

The processor 120 may decrypt an encrypted similarity score by using the trusted execution environment 6000. The trusted execution environment 6000 may provide a result of decrypting the encrypted similarity score to the data item identification module 3000. In this case, the decryption result may include a similarity score indicating a semantic relation between the query embedding and an embedding corresponding to each of the plurality of data items.

In an embodiment, the trusted execution environment 6000 may provide an entire result of decrypting the encrypted similarity score to the data item identification module 3000. In another embodiment, the trusted execution environment 6000 may provide only some results identified based on the decrypted similarity score to the data item identification module 3000. For example, the trusted execution environment 6000 may provide, to the data item identification module 3000, identification information of a data item having a similarity score equal to or greater than a predetermined threshold value, identification information of a data item selected based on a ranking of similarity scores, or identification information of a data item having the highest similarity score.

The processor 120 may identify at least one data item related to a search request among a plurality of data items based on a result of decrypting an encrypted similarity score. For example, the processor 120 may identify a data item having the highest similarity score among the plurality of data items as a data item related to the search request. As another example, the processor 120 may identify at least one data item having a similarity score equal to or greater than a predetermined threshold value as at least one data item related to the search request. As still another example, the processor 120 may identify, as at least one data item related to the search request, an upper predetermined number of data items based on a ranking of similarity scores.

In an embodiment, the processor 120 may first acquire information for identifying at least one data item without immediately providing at least one data item itself to the artificial intelligence agent 2000. The information for identifying at least one data item may include at least one of identification information of a data item, a type of the data item, tag information corresponding to the data item, a storage location of the data item, or metadata corresponding to the data item.

The processor 120 may provide a user with the access request information for inquiring whether to allow access to at least one data item by using the user approval module 4000. In an embodiment, the access request information may include at least one of a type of at least one data item, tag information corresponding to at least one data item, or a target to which at least one data item is to be provided.

The processor 120 may receive a user input as a response to the access request information. When a user input for allowing access to at least one data item is received, the processor 120 may provide at least one data item to be available for use by the artificial intelligence agent 2000 by using the data provision module 5000.

In an embodiment, the processor 120 may determine whether to provide at least one data item or a provision range of at least one data item based on a user input. For example, the processor 120 may provide only at least one of a data item itself, metadata corresponding to the data item, summary information, tag information, or a part of the data item to be available for use by the artificial intelligence agent 2000 according to the user input.

In an embodiment, the processor 120 may provide at least one data item itself to the artificial intelligence agent 2000. In another embodiment, the processor 120 may provide at least one of metadata, summary information, tag information, or a part of a data item corresponding to at least one data item to the artificial intelligence agent 2000.

In an embodiment, when a user input for not allowing access to at least one data item is received, the processor 120 may not provide at least one data item to the artificial intelligence agent 2000. In this case, the processor 120 may allow a response to a user query to be generated without using at least one data item.

In an embodiment, the artificial intelligence agent 2000, that is, the artificial intelligence agent 2000 described above, may be a first artificial intelligence agent, and the external artificial intelligence agent 7000 may be a second artificial intelligence agent. The external artificial intelligence agent 7000 may refer to an artificial intelligence agent executed in a server, a cloud system, an external application, or an external service outside the electronic apparatus 100. In another embodiment, the external artificial intelligence agent 7000 may be another artificial intelligence agent executed in the electronic apparatus 100 and distinguished from the artificial intelligence agent 2000.

The processor 120 may receive, from the artificial intelligence agent 2000, an external provision request for providing at least one data item to the external artificial intelligence agent 7000. The external provision request may include at least one of identification information of the external artificial intelligence agent 7000, information on a task to be performed by the external artificial intelligence agent 7000, or a range of data to be provided to the external artificial intelligence agent 7000.

In an embodiment, the external provision request may be generated through an inter-agent interface for task delegation, data provision, or cooperation between the first artificial intelligence agent and the second artificial intelligence agent. For example, the external provision request may be generated based on an agent-to-agent (A2A) protocol, and is not limited thereto.

In an embodiment, the artificial intelligence agent 2000 may generate an external provision request when determining that a function, a tool, a service, or data processing of the external artificial intelligence agent 7000 is required to generate a response to a user query or perform a task corresponding to the user query. For example, the external provision request may include information indicating which task among travel itinerary recommendation, flight ticket search, accommodation reservation, image analysis, or content summary a task to be performed by the external artificial intelligence agent 7000 corresponds to.

The processor 120 may provide, based on user approval for the external provision request, at least one data item to be available for use by the external artificial intelligence agent 7000. Specifically, the processor 120 may provide a user with external provision approval information for inquiring whether to provide at least one data item to the external artificial intelligence agent 7000 by using the user approval module 4000.

The external provision approval information may include at least one of identification information of the external artificial intelligence agent 7000, information on a task to be performed by the external artificial intelligence agent 7000, or a range of data to be provided to the external artificial intelligence agent 7000. When the user approves external provision, the processor 120 may provide at least one data item to be available for use by the external artificial intelligence agent 7000 by using the data provision module 5000. When the user does not approve external provision, the processor 120 may not provide at least one data item to the external artificial intelligence agent 7000.

In an embodiment, the processor 120 may provide at least one data item itself to the external artificial intelligence agent 7000. In another embodiment, the processor 120 may provide at least one of metadata, summary information, tag information, or a part of a data item corresponding to at least one data item to the external artificial intelligence agent 7000. Accordingly, the processor 120 may control data to be provided only within a range required for the external artificial intelligence agent 7000 to perform a task corresponding to a user query.

In an embodiment, the processor 120 may identify at least one data item based on a search request in a state in which the artificial intelligence agent 2000 does not have application-based access authority to a plurality of data items stored in the memory 110. For example, the artificial intelligence agent 2000 may not have access authority to all of photos, messages, or schedule information stored in the data item DB. Even in this case, the processor 120 may identify whether at least one data item related to a user query exists by using the homomorphically encrypted embedding DB and the trusted execution environment 6000.

In an embodiment, the processor 120 may store, as log information, at least one of a search request, a search result based on an encrypted similarity score, a user approval result, an external provision request, or an external provision approval result. The log information may include at least one of a time point at which the search request is received, identification information of the artificial intelligence agent 2000, a type of an identified data item, whether user approval is acquired, a provision range allowed by a user, identification information of the external artificial intelligence agent 7000, or a time point at which data is provided.

In an embodiment, the processor 120 may generate consent proof information based on a user input. The consent proof information may indicate at least one of a range of a data item allowed by a user, a provision target, or a usage purpose.

Accordingly, the processor 120 may identify at least one data item semantically related to a user query even in a state in which the artificial intelligence agent 2000 does not directly access all of a plurality of data items.

In addition, the processor 120 may reduce direct exposure of a decryption key or a semantic feature of a data item to the artificial intelligence agent 2000 by performing decryption of an encrypted similarity score by using the trusted execution environment 6000.

In addition, the processor 120 may acquire user approval before at least one data item is provided to the external artificial intelligence agent 7000, thereby allowing whether to provide user data or a provision range of the user data to be controlled by a user even in a cooperation process between artificial intelligence agents.

In addition, the electronic apparatus 100 may track a provision history and a provision range of user data even in an environment in which a plurality of artificial intelligence agents cooperate with each other, by managing a data provision request for the external artificial intelligence agent 7000 and a user approval result as log information or consent proof information.

In an embodiment, operations of the electronic apparatus 100, the embedding DB construction module 1000, the artificial intelligence agent 2000, the data item identification module 3000, the user approval module 4000, the data provision module 5000, the trusted execution environment 6000, and the external artificial intelligence agent 7000 described above with reference to FIG. 4 may be implemented as a system-level privacy infrastructure for mediating data access of an artificial intelligence agent in the electronic apparatus 100 or a computing platform interworking with the electronic apparatus 100. The embodiments described below may not be for replacing the embodiments described above, and may be embodiments for performing the operations described above more specifically at an operating system or platform service level.

In an embodiment, the electronic apparatus 100 or the computing platform may provide a privacy mediation layer implemented as a system service, a platform service, a local agent proxy, or a data access mediation layer at an operating system or platform service level. The privacy mediation layer may identify a data item or a derived context corresponding to a purpose of a user query even in a state in which the artificial intelligence agent 2000 does not have comprehensive application-based or file-based access authority to user data items, and may determine a range of information providable to the artificial intelligence agent 2000 based on a privacy-related label and policy information. Accordingly, the electronic apparatus 100 or the computing platform may support a personalized artificial intelligence service by providing an activity tag, summary information, metadata, a partial field, or a redacted derived context without directly providing an original data item or a sensitive embedding.

In an embodiment, the privacy mediation layer may acquire a plurality of data items from user apps or data sources (User Apps/Data Sources). The user apps or data sources may include at least one of an application installed in the electronic apparatus 100, a storage managed by an operating system, a system service, a content provider, a file storage region, a photo storage region, a message storage region, a schedule storage region, a location information storage region, an audio storage region, or a data source provided from an external device.

In an embodiment, the privacy mediation layer may acquire a plurality of embeddings respectively corresponding to the plurality of data items by using an on-device embedding pipeline (On-device Embedding Pipeline). The on-device embedding pipeline may refer to a configuration for converting a semantic feature of a data item into a vector form by using at least one embedding model executed in the electronic apparatus 100. For example, the on-device embedding pipeline may generate an embedding corresponding to at least one of text, a photo, audio, a video, schedule information, location information, or an application usage history.

In an embodiment, the privacy mediation layer may acquire privacy-related labels respectively corresponding to the plurality of embeddings by using a semantic privacy classifier or labeler (Semantic Privacy Classifier/Labeler). A privacy-related label may refer to information indicating a type of sensitive information that may be included in an embedding or a data item corresponding to the embedding. For example, the privacy-related label may include a label corresponding to at least one of location information, personal identification information, health information, financial information, relationship information, behavioral history, or sensitive activity information. The processor 120 may generate the privacy-related label and confidence information of the label by using at least one of a rule-based filter or a trained classifier.

In an embodiment, the processor 120 may encrypt at least some embeddings among the plurality of embeddings by using a homomorphic encryption scheme and store the encrypted embeddings in an encrypted embedding storage region. The encrypted embedding storage region may be implemented as an encrypted vector embedding DB (Encrypted Vector Embedding DB). The encrypted vector embedding DB may be included in at least one of the memory 110, a system-managed storage managed by an operating system, a secure storage region, or a storage region managed by the privacy mediation layer.

In an embodiment, the processor 120 may store identification information of an encrypted embedding and identification information of a data item in a mapped manner. In addition, the processor 120 may store, in a metadata DB (Metadata DB), at least one of a type of a data item, a modality of the data item, tag information, metadata, a privacy-related label, or confidence information of the label. The metadata DB may be implemented as a storage region separate from the encrypted vector embedding DB, or may be implemented as one storage region logically distinguished from the encrypted vector embedding DB.

In an embodiment, the privacy mediation layer may provide an authorized system interface that is callable in a state in which the artificial intelligence agent 2000 does not have application-based or file-based access authority to the plurality of data items. The authorized system interface may be implemented based on at least one of an inter-process communication interface, a system service call interface, a data provider interface, a system-managed storage interface, an agent interface, a model context interface, or a combination thereof, provided by the electronic apparatus 100, the operating system, or the computing platform.

In an embodiment, the privacy mediation layer may include a local agent proxy (Local Agent Proxy) or a system service (System Service). The local agent proxy may refer to a configuration that relays or processes at least one of a search request, access request information, a user input, an external provision request, or consent proof information between the artificial intelligence agent 2000 and the privacy mediation layer. The system service may refer to an authorized service provided by the operating system or computing platform of the electronic apparatus 100 and configured to mediate data access of the artificial intelligence agent 2000.

In an embodiment, when a search request including a query embedding generated based on a user query and request purpose information is received from the artificial intelligence agent 2000, the processor 120 may calculate an encrypted similarity score by performing, without decryption, a similarity operation between the query embedding and at least some embeddings encrypted using the homomorphic encryption scheme. The request purpose information may refer to information indicating a purpose for which the artificial intelligence agent 2000 generates the search request or a purpose of a task to be performed by the artificial intelligence agent 2000.

In an embodiment, the processor 120 may identify, by using an access policy layer (Access Policy Layer), at least one data item or a derived context that is related to the search request and providable to the artificial intelligence agent 2000 among the plurality of data items, based on a result of decrypting the encrypted similarity score, the privacy-related label, and the predefined policy information. The access policy layer may be included in the privacy mediation layer, or may be implemented as a separate software module or system service interworking with the privacy mediation layer.

In an embodiment, the predefined policy information may include information for determining a range of search target embeddings or a range of providable information based on at least one of a type of the privacy-related label, confidence of the privacy-related label, a purpose of the search request, identification information of the artificial intelligence agent 2000, identification information of a receiving agent, a user consent token, or a modality of a data item. The user consent token may refer to information generated based on a user input or a user approval result and indicating at least one of an allowed data range, a provision target, a usage purpose, a valid period, or an approval time point.

In an embodiment, when a provision request for the external artificial intelligence agent 7000 is included, the access policy layer may determine a range of information providable to the artificial intelligence agent 2000 and a range of information providable to the external artificial intelligence agent 7000 differently from each other. For example, the access policy layer may determine metadata or a partial field corresponding to a data item as information providable to the artificial intelligence agent 2000 executed on-device, and may determine only a redacted derived context as information providable to the external artificial intelligence agent 7000.

In an embodiment, when a location information label and a personal identification information label are assigned together to a photo data item, the processor 120 may restrict provision of an original image or an embedding including personal identification information by using the access policy layer, and may determine an activity tag or abstracted information of a location category required for the user query as providable information.

In an embodiment, a derived context may refer to information derived from at least one of at least one data item, an embedding corresponding to the at least one data item, metadata, tag information, summary information, or a partial field. A redacted derived context may refer to a derived context generated by excluding original content of at least one data item or an embedding including personal identification information. For example, the redacted derived context may include at least one of an activity tag related to the user query, abstracted information of a location category, a preference summary, a schedule category, a cost category, or a partial attribute of a data item.

In an embodiment, the processor 120 may provide the user with access request information including at least one of a provision range, a provision target, or a usage purpose of at least one data item or a derived context. Based on a user input for the access request information, the processor 120 may provide at least one of the at least one data item itself, metadata corresponding to the at least one data item, tag information, summary information, a partial field, or a redacted derived context to be available for use by the artificial intelligence agent 2000.

In an embodiment, the processor 120 may provide access request information to the user by using a consent UI (Consent UI) or a conversational prompt generator (Conversational Prompt Generator). The consent UI may refer to a user interface provided to allow the user to check and approve or reject at least one of whether to provide a data item or a derived context, a provision range, a provision target, or a usage purpose. The conversational prompt generator may refer to a configuration for generating a natural language access request prompt explaining a range and a usage purpose of data to which the artificial intelligence agent 2000 attempts to access, based on at least one of content of a user query, a purpose of a search request, a privacy-related label, or a provision target.

In an embodiment, the processor 120 may adjust a provision range or generate a subsequent confirmation prompt based on a user response to the natural language access request prompt. For example, when the user response does not allow provision of an original data item and allows only provision of an activity tag, the processor 120 may not provide the original data item and may provide the activity tag or a redacted derived context to be available for use by the artificial intelligence agent 2000.

In an embodiment, the artificial intelligence agent 2000 may be a first artificial intelligence agent. The processor 120 may receive, from the first artificial intelligence agent, an external provision request for task delegation or data provision to a second artificial intelligence agent. The external provision request may include at least one of identification information of the second artificial intelligence agent, a task to be performed by the second artificial intelligence agent, a range of information to be provided to the second artificial intelligence agent, or a usage purpose.

In an embodiment, when the external provision request is received, the processor 120 may provide the user with external provision approval information including at least one of identification information of the second artificial intelligence agent, a task to be performed by the second artificial intelligence agent, a range of information to be provided to the second artificial intelligence agent, or a usage purpose. Based on user approval for the external provision approval information, the processor 120 may provide at least one of metadata, tag information, summary information, a partial field, or a redacted derived context to be available for use by the second artificial intelligence agent. Task delegation or data provision between the first artificial intelligence agent and the second artificial intelligence agent may be performed based on an agent-to-agent (A2A) protocol or a corresponding inter-agent collaboration interface.

In an embodiment, the processor 120 may generate consent proof information or an agent manifest based on a user input. The consent proof information may refer to information indicating a data range, a provision target, or a usage purpose allowed by the user. The agent manifest may refer to information indicating a task to be performed by an artificial intelligence agent, a range of data to be used, a provision target, or a usage purpose. The consent proof information or the agent manifest may include at least one of an allowed data range, a provision target, a usage purpose, a valid period, an approval time point, identification information of a requesting agent, identification information of a receiving agent, or a user approval result.

In an embodiment, the processor 120 may generate the agent manifest or the consent proof information by using an agent manifest or consent proof generator (Agent Manifest/Consent Proof Generator). The agent manifest or consent proof generator may refer to a configuration for generating the agent manifest or the consent proof information based on at least one of a request of the first artificial intelligence agent, an external provision request, a user input, a determination result of the access policy layer, or external provision approval information.

In an embodiment, the consent proof information may be transmitted to the second artificial intelligence agent through an A2A protocol or a corresponding inter-agent collaboration protocol. In another embodiment, the consent proof information may not be directly provided to the external artificial intelligence agent 7000, and may be stored in the privacy mediation layer, the trusted execution environment 6000, or an audit log.

In an embodiment, the processor 120 may store log information including at least one of a reception time point of a search request, a search result, identification information of the artificial intelligence agent 2000, a purpose of the search request, a type of an identified data item, whether user approval is acquired, a provision range allowed by the user, whether external provision is performed, an external provision target, or a data provision time point. The log information may be used as an audit log (Audit Log), and may be provided as information for allowing the user to subsequently check which artificial intelligence agent used which range of user-related information for which purpose. Accordingly, transparency and accountability traceability of a user data use process may be improved even in an environment in which a plurality of artificial intelligence agents cooperate with each other.

In an embodiment, the trusted execution environment 6000 may include or interwork with a key management layer (Key Management). The key management layer may manage key information related to homomorphically encrypted embeddings or encrypted similarity scores in the trusted execution environment 6000 separated from a general application region and an execution region of an artificial intelligence agent. For example, the trusted execution environment 6000 may be implemented based on at least one of a hardware-based secure isolation region, a trusted execution region, a secure processor, a secure storage region, or a corresponding key protection region.

In an embodiment, the trusted execution environment 6000 may manage a decryption key for decrypting an encrypted similarity score, and may not provide the decryption key to the artificial intelligence agent 2000 or the second artificial intelligence agent. The trusted execution environment 6000 may output at least one of identification information of a data item corresponding to a predetermined threshold value or higher or an upper ranking, a providable derived context, an allowable derived context, or a policy determination result, without providing an entire result of decrypting the encrypted similarity score to the outside. Accordingly, direct exposure of a decryption key and a sensitive semantic feature to the artificial intelligence agent 2000 or the external artificial intelligence agent 7000 may be reduced.

In an embodiment, unlike an access control scheme based on application-specific authority settings, the electronic apparatus 100 may determine whether to provide a data item or a derived context or determine a provision range of the data item or the derived context based on a task purpose of an artificial intelligence agent, a context of a user query, a privacy-related label, and policy information. Accordingly, the electronic apparatus 100 may allow only information related to a user query to be used in a restricted manner without granting comprehensive access authority to all of the plurality of data items, thereby changing a scheme of data access control in an artificial intelligence agent-based user experience from an application-centric scheme to a context-centric scheme.

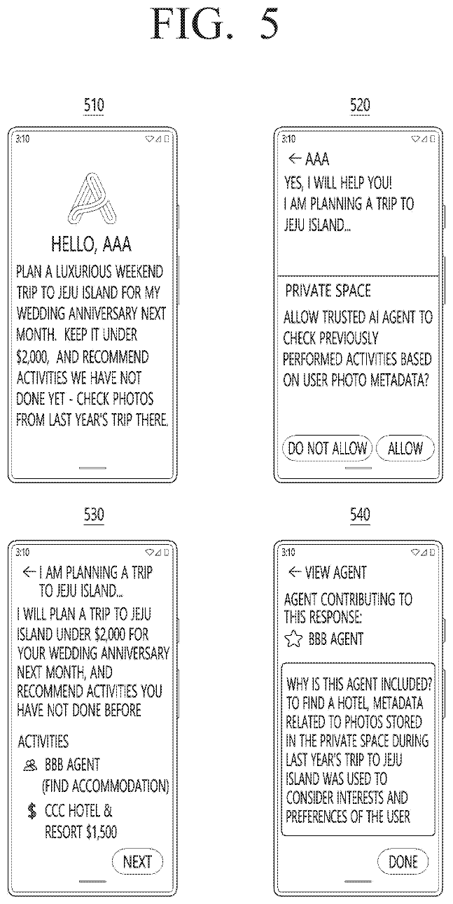

FIG. 5 is a diagram illustrating examples of user interfaces according to an embodiment of the present disclosure.

FIG. 5 is a diagram illustrating an example of a conversational user interface according to an embodiment of the present disclosure.

In an embodiment, the processor 120 may provide access request information for at least one data item through a conversational user interface corresponding to a user query, and may determine whether to provide at least one data item or a provision range of at least one data item based on a user input received through the conversational user interface.

In an embodiment, when at least one data item is identified, the processor 120 may provide a user with access request information for inquiring whether to allow access to at least one data item, and may receive a user input as a response to the access request information. In addition, before at least one data item is provided to the artificial intelligence agent, the processor 120 may provide the user with access request information including at least one of a type of at least one data item, tag information corresponding to at least one data item, or a target to which at least one data item is to be provided.

In an embodiment, the artificial intelligence agent may be the first artificial intelligence agent. The processor 120 may receive, from the first artificial intelligence agent, an external provision request for providing at least one data item to the second artificial intelligence agent, and may provide at least one data item to be available for use by the second artificial intelligence agent based on user approval for the external provision request. The external provision request may include at least one of identification information of the second artificial intelligence agent, information on a task to be performed by the second artificial intelligence agent, or a range of data to be provided to the second artificial intelligence agent.

In the present disclosure, a conversational user interface (UI) may refer to a user interface for performing at least one of input of a user query, provision of access request information, receiving of a user input, provision of a response to a user query, provision of information on an agent contributing to generating the response, or provision of a reason why the agent is included in generating the response.

Referring to FIG. 5, the conversational user interface may include a first user interface 510, a second user interface 520, a third user interface 530, and a fourth user interface 540. In an embodiment, the processor 120 may sequentially provide the first user interface 510, the second user interface 520, the third user interface 530, and the fourth user interface 540 based on a user input.

The first user interface 510 may indicate a state in which a user query is input. The first user interface 510 may include text “Hello, AAA.” The text “Hello, AAA” may be greeting information provided to a user in a state in which the artificial intelligence agent identifies the user AAA.

The first user interface 510 may include text “Plan a luxurious weekend trip to Jeju Island for my wedding anniversary next month. Keep it under $2,000, and recommend activities we have not done yet-check photos from last year's trip there.” The above text may indicate a user query.

Specifically, “my wedding anniversary next month” may indicate a travel time point and a travel purpose, “a luxurious weekend trip to Jeju Island” may indicate a travel destination and a travel characteristic, and “Keep it under $2,000” may indicate a budget condition. In addition, “recommend activities we have not done yet” may indicate a personalized recommendation condition, and “check photos from last year's trip there” may indicate a range of a data item to be referred to by the artificial intelligence agent.

The second user interface 520 may indicate access request information for inquiring whether to allow access to at least one data item based on a user query. The second user interface 520 may include text “Yes, I will help you! I am planning a trip to Jeju Island . . . ” The above text may be response information indicating that the artificial intelligence agent receives the user query and starts a task for the user query.

The second user interface 520 may include text “private space.” The “private space” may refer to a region in which user data, particularly, a data item related to user privacy is stored or managed. For example, the “private space” may refer to a region in which photos, messages, schedule information, or metadata related thereto are stored.

The second user interface 520 may include text “Would you allow a trusted AI agent to check previously performed activities by considering the user photo metadata?” The above text may indicate access request information. “A trusted AI agent” may indicate an artificial intelligence agent to use at least one data item, “the user photo metadata” may indicate a type of an access target data item or information corresponding to a data item, and “check previously performed activities”may indicate a usage purpose of data.

The second user interface 520 may include a “Do not allow” object and an “Allow” object. The “Do not allow” object may be an object for receiving a user input for not allowing access to at least one data item. The “Allow” object may be an object for receiving a user input for allowing access to at least one data item.

In an embodiment, when a user input for the “Do not allow” object is received, the processor 120 may not provide at least one data item to the artificial intelligence agent. When a user input for the “Allow” object is received, the processor 120 may provide at least one data item or metadata corresponding to at least one data item to be available for use by the artificial intelligence agent.

The third user interface 530 may indicate a state in which a response to a user query is generated after at least one data item is provided to be available for use based on a user input. The third user interface 530 may include text “Plan a trip to Jeju Island under $2,000 for your wedding anniversary next month, and recommend activities you have not done before.” This text may indicate that a travel time point, a destination, a budget condition, and a recommendation condition included in the user query are reflected in generating the response.

The third user interface 530 may include text “activities.” The “activities” may indicate a category of a detailed item recommended or planned in response to a user query. The detailed item recommended or planned in response to the user query may include “BBB agent (find accommodation).” “BBB agent” may indicate identification information of an agent that performs at least some of tasks corresponding to the user query. “(find accommodation)” may indicate content of a task performed by the BBB agent. In an embodiment, the BBB agent may be an external artificial intelligence agent.

The detailed item recommended or planned in response to the user query may include “CCC Hotel & Resort $1,500.” This item may indicate accommodation information and cost information recommended in response to the user query. “CCC Hotel & Resort” may indicate a name of recommended accommodation, and “$1,500” may indicate cost information corresponding to the recommended accommodation or a travel plan. In an embodiment, “$1,500” may be information satisfying a budget condition of “under $2,000” included in the user query.

The third user interface 530 may include a “Next” object. The “Next” object may be an object for receiving a user input for checking additional information, a subsequent screen, or information on an agent contributing to generating the response.

The fourth user interface 540 may indicate information on an agent contributing to generating the response. The fourth user interface 540 may include text “Agent contributing to this response” and “BBB agent.” The above text may indicate a name, identification information, or role information of the agent currently contributing to generating the response.

The fourth user interface 540 may include text “Why is this agent included?” and “To find a hotel, metadata related to photos stored in the private space during last year's trip to Jeju Island was used to consider interests and preferences of the user.” The above text may indicate a purpose of a task performed by the agent contributing to generating the response, a range of used data, and user-related information considered. “To find a hotel” may indicate a purpose of the performed task, “metadata related to photos stored in the private space during last year's trip to Jeju Island” may indicate a range of used data, and “consider interests and preferences of the user” may indicate that the data is used for generating a personalized response.

The fourth user interface 540 may include a “Done” object. The “Done” object may be an object for receiving a user input for ending checking of agent information.

In an embodiment, the processor 120 may acquire a user query through the first user interface 510, provide access request information through the second user interface 520, determine whether to provide at least one data item or a provision range of at least one data item based on a user input received through the second user interface 520, provide a response based on at least one data item through the third user interface 530, and provide an agent contributing to generating the response and a reason for including the agent through the fourth user interface 540.

Accordingly, the processor 120 may control whether to use a user-related data item and a range of using the user-related data item based on a user input in a response generation process corresponding to a user query. In addition, the processor 120 may improve transparency of a user data usage process by providing an agent contributing to generating the response and a range of data used by the agent.

In addition, in a process in which the artificial intelligence agent 2000 performs a task corresponding to a user query, the electronic apparatus 100 may dynamically control access authority to a data item based on a context of the user query, a type of an identified data item, and a usage purpose of the data item, instead of setting access authority to the data item on an application basis. That is, the electronic apparatus 100 may provide access request information to a user at a time point at which a data item related to a search request is identified, and may provide the data item to be available for use by the artificial intelligence agent 2000 only within a range allowed by a user input, instead of granting or blocking access authority to all of photos, messages, or schedule information to a specific application.

In addition, unlike a conventional access control scheme premised on application-specific authority setting, the electronic apparatus 100 may determine whether to provide a data item or a provision range of the data item based on a task purpose of the artificial intelligence agent 2000 and a context of a user query. Accordingly, the electronic apparatus 100 may switch a scheme of data access control in an artificial intelligence agent-based user experience from an application-centered scheme to a context-centered scheme by allowing only a data item related to a user query to be used in a restricted manner without granting, to the artificial intelligence agent, comprehensive access authority to all of a plurality of data items.

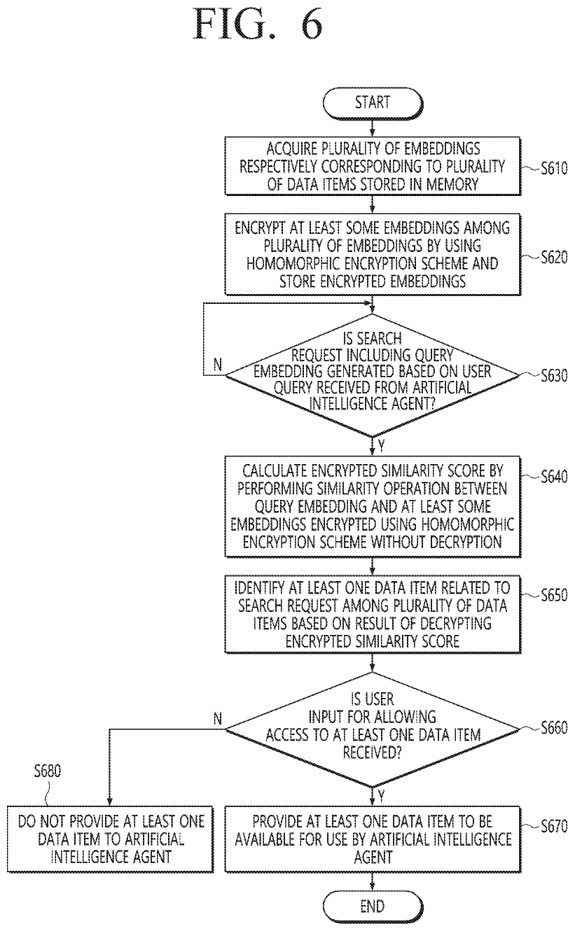

FIG. 6 is a flowchart illustrating a controlling method of an electronic apparatus 100 according to an embodiment of the present disclosure.

In the following embodiments, respective operations may be sequentially performed. However, the operations are not necessarily sequentially performed. For example, an order of the operations may be changed, and at least two operations may be performed in parallel.

According to one or more embodiments, operations S610 to S680 may be performed by at least one processor 120 of the electronic apparatus 100.

As illustrated in FIG. 6, the electronic apparatus 100 may acquire a plurality of embeddings respectively corresponding to a plurality of data items (S610). In an embodiment, the plurality of data items may include user-related data stored in the memory 110, and the plurality of embeddings may indicate semantic features of each of the plurality of data items.

The electronic apparatus 100 may encrypt at least some embeddings among the plurality of embeddings by using a homomorphic encryption scheme and store the encrypted embeddings (S620). In an embodiment, the electronic apparatus 100 may encrypt and store all of the plurality of embeddings, or may identify some embeddings requiring privacy protection among the plurality of embeddings and encrypt and store the identified some embeddings. Accordingly, the electronic apparatus 100 may provide a basis for performing a similarity operation without decrypting encrypted embeddings even when a search request is received subsequently.

When a search request including a query embedding generated based on a user query is received from the artificial intelligence agent (S630-Y), the electronic apparatus 100 may calculate an encrypted similarity score by performing a similarity operation between the query embedding and at least some embeddings encrypted using a homomorphic encryption scheme without decryption (S640). In an embodiment, the electronic apparatus 100 may calculate a similarity score indicating a semantic relation with encrypted embeddings in a ciphertext state based on the query embedding included in the search request. When the search request is not received (S630-N), the electronic apparatus 100 may wait for reception of the search request.

The electronic apparatus 100 may identify at least one data item related to a search request among a plurality of data items based on a result of decrypting an encrypted similarity score (S650). In an embodiment, the electronic apparatus 100 may identify at least one data item related to a user query based on at least one of a magnitude of a decrypted similarity score, a ranking of the decrypted similarity score, or a comparison result between the decrypted similarity score and a predetermined threshold value. In this case, the electronic apparatus 100 may inquire of a user whether to allow access to the data item without immediately providing original content of the identified data item to the artificial intelligence agent.

When a user input for allowing access to at least one data item is received (S660-Y), the electronic apparatus 100 may provide at least one data item to be available for use by the artificial intelligence agent (S670). In an embodiment, the electronic apparatus 100 may provide at least one of at least one data item itself, metadata corresponding to at least one data item, summary information, or tag information to be available for use by the artificial intelligence agent within a range allowed by a user input.

When a user input for not allowing access to at least one data item is received (S660-N), the electronic apparatus 100 may not provide at least one data item to the artificial intelligence agent (S680). In an embodiment, the electronic apparatus 100 may allow a response to a user query to be generated without using at least one data item, or may request an additional input from a user.

Accordingly, the electronic apparatus 100 may control a data item related to a user query to be used only within a user approval range by combining an encrypted embedding-based search result with a user input.

Meanwhile, the controlling method of the electronic apparatus 100 according to the above-described embodiment may be implemented as a program and provided to the electronic apparatus 100. In particular, a program including the controlling method of the electronic apparatus 100 may be stored and provided in a non-transitory computer-readable medium.

Specifically, in the non-transitory computer-readable recording medium including the program for executing the controlling method of the electronic apparatus 100, the controlling method of the electronic apparatus 100 may include: acquiring a plurality of embeddings respectively corresponding to a plurality of data items; encrypting at least some embeddings among the plurality of embeddings by using a homomorphic encryption scheme and storing the encrypted embeddings; when a search request including a query embedding generated based on a user query is received from an artificial intelligence agent, calculating an encrypted similarity score by performing a similarity operation between the query embedding and at least some embeddings encrypted using the homomorphic encryption scheme without decryption; identifying at least one data item related to the search request among the plurality of data items based on a result of decrypting the encrypted similarity score; and when a user input for allowing access to at least one data item is received, providing at least one data item to be available for use by the artificial intelligence agent.

Although the controlling method of the electronic apparatus 100 and the computer-readable recording medium including the program for executing the controlling method of the electronic apparatus 100 are briefly described above, the description is provided merely to omit redundant description, and various embodiments of the electronic apparatus 100 may also be applied to the controlling method of the electronic apparatus 100 and the computer-readable recording medium including the program for executing the controlling method of the electronic apparatus 100.

Although the embodiments of the present disclosure have been illustrated and described above, the present disclosure is not limited to the above-described specific embodiments, and various modifications may be made by those skilled in the art to which the present disclosure pertains without departing from the gist of the present disclosure as claimed in the claims, and these modifications should not be individually understood apart from the spirit or scope of the present disclosure.

What is claimed is:

1. An electronic apparatus comprising:
at least one memory storing instructions; and
at least one processor including processing circuitry,
wherein the instructions, when executed individually or collectively by the at least one processor, cause the electronic apparatus to:
acquire a plurality of embeddings respectively corresponding to a plurality of data items stored in the memory;
encrypt at least some embeddings among the plurality of embeddings by using a homomorphic encryption scheme and store the encrypted embeddings in the memory;
when a search request including a query embedding generated based on a user query is received from an artificial intelligence agent, calculate an encrypted similarity score by performing a similarity operation between the query embedding and the at least some embeddings encrypted using the homomorphic encryption scheme without decryption;
identify at least one data item related to the search request among the plurality of data items based on a result of decrypting the encrypted similarity score; and
when a user input for allowing access to the at least one data item is received, provide the at least one data item to be available for use by the artificial intelligence agent.

2. The apparatus as claimed in claim 1, wherein the instructions, when executed individually or collectively by the at least one processor, cause the electronic apparatus to:
when the at least one data item is identified, provide a user with access request information for inquiring whether to allow access to the at least one data item; and
receive the user input as a response to the access request information.

3. The apparatus as claimed in claim 2, wherein the instructions, when executed individually or collectively by the at least one processor, cause the electronic apparatus to:
before the at least one data item is provided to the artificial intelligence agent, provide the user with the access request information including at least one of a type of the at least one data item, tag information corresponding to the at least one data item, or a target to which the at least one data item is to be provided.

4. The apparatus as claimed in claim 2, wherein the instructions, when executed individually or collectively by the at least one processor, cause the electronic apparatus to:
when a user input for not allowing access to the at least one data item is received, not provide the at least one data item to the artificial intelligence agent, and allow a response to the user query to be generated without using the at least one data item.

5. The apparatus as claimed in claim 1, wherein the artificial intelligence agent is a first artificial intelligence agent, and
the instructions, when executed individually or collectively by the at least one processor, cause the electronic apparatus to:
receive, from the first artificial intelligence agent, an external provision request for providing the at least one data item to a second artificial intelligence agent; and
provide, based on user approval for the external provision request, the at least one data item to be available for use by the second artificial intelligence agent.

6. The apparatus as claimed in claim 5, wherein the external provision request includes at least one of identification information of the second artificial intelligence agent, information on a task to be performed by the second artificial intelligence agent, or a range of data to be provided to the second artificial intelligence agent.

7. The apparatus as claimed in claim 1, wherein the instructions, when executed individually or collectively by the at least one processor, cause the electronic apparatus to:
acquire privacy-related labels respectively corresponding to the plurality of data items;
identify, based on the privacy-related labels and predefined policy information, an encryption target embedding to be encrypted and stored by using the homomorphic encryption scheme among the plurality of embeddings; and
identify the at least some embeddings as the encryption target embeddings.

8. The apparatus as claimed in claim 1, wherein decryption of the encrypted similarity score is performed based on a decryption key managed in a trusted execution environment included in the electronic apparatus and inaccessible to the artificial intelligence agent, and
the trusted execution environment outputs information for identifying the at least one data item based on a result of decrypting the encrypted similarity score, and does not provide the decryption key to the artificial intelligence agent.

9. The apparatus as claimed in claim 1, wherein the instructions, when executed individually or collectively by the at least one processor, cause the electronic apparatus to:
identify the at least one data item based on the search request in a state in which the artificial intelligence agent does not have application-based access authority to the plurality of data items stored in the memory.

10. The apparatus as claimed in claim 9, wherein the instructions, when executed individually or collectively by the at least one processor, cause the electronic apparatus to:
provide access request information for the at least one data item through a conversational user interface corresponding to the user query; and
determine whether to provide the at least one data item or a provision range of the at least one data item based on the user input received through the conversational user interface.

11. A controlling method of an electronic apparatus, the method comprising:
acquiring a plurality of embeddings respectively corresponding to a plurality of data items;
encrypting at least some embeddings among the plurality of embeddings by using a homomorphic encryption scheme and storing the encrypted embeddings;
when a search request including a query embedding generated based on a user query is received from an artificial intelligence agent, calculating an encrypted similarity score by performing a similarity operation between the query embedding and the at least some embeddings encrypted using the homomorphic encryption scheme without decryption;
identifying at least one data item related to the search request among the plurality of data items based on a result of decrypting the encrypted similarity score; and
when a user input for allowing access to the at least one data item is received, providing the at least one data item to be available for use by the artificial intelligence agent.

12. An electronic apparatus comprising:
at least one memory storing instructions; and
at least one processor including processing circuitry,
wherein the instructions, when executed individually or collectively by the at least one processor, cause the electronic apparatus to:
acquire, through a system service, a platform service, a local agent proxy, or a data access mediation layer operating at an operating system or platform service level of the electronic apparatus or a computing platform interworking with the electronic apparatus, a plurality of embeddings respectively corresponding to a plurality of data items and privacy-related labels respectively corresponding to the plurality of embeddings;
encrypt at least some embeddings among the plurality of embeddings by using a homomorphic encryption scheme and store the encrypted embeddings in an encrypted embedding storage region;
when a search request including a query embedding generated based on a user query and request purpose information is received from an artificial intelligence agent, calculate an encrypted similarity score by performing, without decryption, a similarity operation between the query embedding and the at least some embeddings encrypted using the homomorphic encryption scheme;
identify, among the plurality of data items, at least one data item or a derived context that is related to the search request and providable to the artificial intelligence agent, based on a result of decrypting the encrypted similarity score, the privacy-related labels, and predefined policy information;
provide a user with access request information including at least one of a provision range, a provision target, or a usage purpose of the at least one data item or the derived context; and
provide, based on a user input for the access request information, at least one of the at least one data item itself, metadata corresponding to the at least one data item, tag information, summary information, a partial field, or a redacted derived context to be available for use by the artificial intelligence agent.
